(19) United States
(12) Patent Application Publication
(10) Pub. No.: US 2024/0353069 A1
(43) Pub. Date: Oct. 24, 2024

(54) METHOD AND CONVEYING DEVICE

(71) Applicant: Linde GmbH, Pullach (DE)

(72) Inventors: Anton WELLENHOFER, Pullach (DE); Eva MÜLLER, Pullach (DE); Stefan FELBINGER, Pullach (DE); Clemens WOLFERSTETTER, Pullach (DE); Harald ZENZ, Pullach (DE); Kathrin WELLENHOFER, Pullach (DE); Nabeel HAKEMI, Pullach (DE); Petya TONEVA, Pullach (DE); Jose Albert CRUZ, Pullach (DE); Denis DURNEV, Pullach (DE); Johannes SCHAFRANEK, Pullach (DE)

(21) Appl. No.: 18/684,520

(22) PCT Filed: Aug. 17, 2022
(86) PCT No.: PCT/EP2022/025381

§ 371 Date: Feb. 16, 2024

(30) Foreign Application Priority Data
Aug. 23, 2021 (EP) 21020422.8

(51) Int. Cl. F17C 9/02

(52) U.S. Cl. CPC F17C 9/02; F17C 2205/0326; F17C 2205/0338; F17C 2223/0161; F17C 2223/033; F17C 2227/0302; F17C 2227/04; F17C 2250/043

(57) ABSTRACT

A method for supplying a consumer with a cryogen from a storage vessel, with the following steps: a) introducing part of the cryogen from the storage vessel into a volume that can be closed off, b) closing off the volume by first closing a supply valve arranged between the volume and the consumer, and then closing an inlet valve arranged between the storage vessel and the volume, c) vaporizing the cryogen in the volume so as to subject the volume to a pressure which is higher than a pressure prevailing in the storage vessel, and d) discharging the vaporized cryogen from the volume to the consumer when the consumer has a load requirement by opening the supply valve, wherein, when the supply valve is open, the inlet valve is opened as soon as the pressure in the volume falls below the pressure prevailing in the storage vessel.

The invention relates to a method for supplying a consumer with a cryogen from a storage vessel, and to a conveying device for supplying a consumer with a cryogen from a storage vessel.

Storage vessels for liquid hydrogen can have a pressure building vaporizer, according to the in-house know-how of the applicant, which makes it possible to build up a pressure within the storage vessel so that gaseous hydrogen can be made available to a consumer, for example, in the form of a fuel cell, with a stable supply pressure of, for example, 1 to 2.5 bara. During the operation of such a storage vessel, for example, in the maritime field, a movement of the storage vessel, for example, due to the swell, can make it very difficult to maintain stable operating conditions in the storage vessel so that the required supply pressure for the fuel cell can be kept constant.

The applicant is also aware of in-house prior art in which the hydrogen is stored in the storage vessel in an approximately pressure-free manner. In this case, the hydrogen is conveyed using a cryogenic pump and supplied to the fuel cell with the previously mentioned supply pressure. However, such a cryogenic pump has moving parts, which can lead to a certain maintenance effort, and thus to operational downtimes. Furthermore, it is also possible according to internal findings to vaporize the hydrogen upstream of the fuel cell and then compress it in order to achieve the required supply pressure. However, this is unfavorable in terms of energy use.

Against this background, the object of the present invention is to provide an improved method for supplying a consumer with a cryogen from a storage vessel.

Accordingly, a method for supplying a consumer with a cryogen from a storage vessel is proposed. The method comprises the following steps: a) introducing part of the cryogen from the storage vessel into a volume that can be closed off from the consumer and from the storage vessel, b) closing off the volume from the consumer and from the storage vessel by first closing a supply valve arranged between the volume and the consumer, and then closing an inlet valve arranged between the storage vessel and the volume, c) vaporizing the cryogen in the volume so as to subject the volume to a pressure which is higher than a pressure prevailing in the storage vessel, and d) discharging the vaporized cryogen from the volume to the consumer when the consumer has a load requirement by opening the supply valve, wherein when the supply valve is open, the inlet valve is opened as soon as the pressure in the volume falls below the pressure prevailing in the storage vessel.

Due to the fact that the volume can be used as a pressure accumulator to supply the consumer with the vaporized cryogen, a movement of the storage vessel, for example when the swell is high, has no negative effects on the supply of the vaporized cryogen to the consumer. The storage vessel can hereby be operated at the lowest possible pressure. This extends the retention time of the cryogen. Furthermore, it is possible to dispense with movable parts such as are present in a cryogenic pump.

The cryogen is preferably hydrogen. The terms, “cryogen” and “hydrogen,” are therefore interchangeable as desired. In principle, however, the cryogen may also be any other cryogen. Examples of cryogenic fluids or liquids, or cryogens for short, are, in addition to the aforementioned hydrogen, liquid helium, liquid nitrogen, or liquid oxygen. A “cryogen” is thus to be understood in particular as a liquid. The cryogen can also be vaporized and converted into the gaseous phase. After vaporization, the cryogen is a gas or can be referred to as gaseous or vaporized cryogen. The term “cryogen” can thus comprise both, namely the gas phase and the liquid phase. The term “vaporized cryogen” here refers preferably only to the gas phase of the cryogen.

A gas zone and an underlying liquid zone are formed in the storage vessel after or while filling the cryogen into the storage vessel. A phase boundary is provided between the gas zone and the liquid zone. After entering the storage vessel, the cryogen thus preferably has two phases with different aggregate states, viz., liquid and gaseous. The liquid-state phase can transition into the gaseous phase, and vice versa. The liquid phase can be referred to as a liquid phase. The gaseous phase can be referred to as a gas phase. A purely liquid filling of the storage vessel is also possible. The pressure prevailing in the storage vessel is preferably about 3.5 bara. The pressure prevailing in the storage vessel is in particular constant.

The consumer is preferably a fuel cell. In the present case, a “fuel cell” is understood to mean a galvanic cell that converts into electrical energy the chemical reaction energy of a continuously supplied fuel, in the present case hydrogen, and of an oxidant, in the present case oxygen. The cryogen is supplied to the consumer itself in particular in gaseous form, with a defined supply pressure. This means that the cryogen is fully vaporized before the consumer or upstream from the consumer. For example, the cryogen is supplied to the consumer with a supply pressure of 1 to 2.5 bara and a temperature of +10 to +25° C. However, the supply pressure can also be up to 6 bara.

As mentioned above, the cryogen may be biphasic. Preferably, in or during step a), the liquid phase or a part of the liquid phase of the cryogen from the storage vessel is introduced into the volume that can be closed off from the consumer and from the storage vessel. A “part” is to be understood in particular to mean that a certain volume of the liquid phase of the cryogen from the storage vessel is conducted into the volume. A remainder of the liquid phase remains in the storage vessel. A valve or a plurality of valves can be provided for this purpose. Steps a) to d) are preferably carried out in succession. In particular, a conveying device explained below is used for carrying out the method.

The volume can be realized, for example, by a container, a pipe loop or the like. The volume can also be referred to as a header or collector. In the present case, the terms “volume”, “header” and “collector” can be exchanged with one another as desired. In the present case, a “volume” is to be understood very generally as a region which can be fluidically closed off from the storage vessel and the consumer and pressurized. The volume thus serves as a pressure accumulator. The volume can therefore also be referred to as a pressure accumulator. This means that the terms “volume” and “pressure accumulator” can be exchanged with one another as desired.

In or during step b), the volume is preferably closed off from the consumer and from the storage vessel by means of valves. The term “close off” is to be understood in the present case as meaning that a fluid connection or a fluidic connection between the volume and the consumer and between the volume and the storage vessel is separated so that the fluid cannot flow from the storage vessel into the closed-off volume, nor can the fluid flow from the closed-off volume to the consumer.

In or during step c), in particular the liquid-state phase of the cryogen remaining in the sealed volume is vaporized. For this purpose, heat is preferably introduced into the cryogen. By vaporizing the cryogen in the closed-off volume, the pressure in the volume increases. For example, the pressure in the volume increases to a pressure of 3 to 10 bara. Preferably, a substantially constant pressure of, for example, 3.5 bara prevails in the storage vessel.

The discharge of the vaporized cryogen in or during step d) from the volume to the consumer preferably takes place with the aid of a valve, in particular a supply valve, which can be controlled depending on the load requirement of the consumer in order to supply the consumer with the vaporized cryogen. The valve is in particular also suitable for supplying the cryogen at the suitable supply pressure to the consumer. In or during step d), a fluid connection or fluidic connection between the volume and the consumer is thus established, so that the vaporized cryogen can flow from the volume to the consumer. In this case, a pressure reduction can be carried out with the aid of the valve.

According to one embodiment, during step d), the pressure prevailing in the volume is reduced to a supply pressure suitable for the consumer when the cryogen is discharged from the volume with the aid of the supply valve.

As mentioned above, the suitable supply pressure can be, for example, 1 to 2.5 bara. A suitable supply temperature can be +10 to +25° C. The supply valve can be controlled with the aid of an open-loop and closed-loop control device in such a way that said valve reduces the pressure prevailing in the closed-off volume to the suitable supply pressure.

According to a further embodiment, the supply pressure suitable for the consumer is lower than the pressure prevailing in the storage vessel.

As mentioned above, the pressure prevailing in the storage vessel can be 3.5 bara. By contrast, the suitable supply pressure is 1 to 2.5 bara. With the aid of the supply valve, the pressure prevailing in the storage vessel can be reduced to the suitable supply pressure.

According to a further embodiment, during step d), the supply valve is opened depending on the load requirement of the consumer.

This means in particular that the supply valve is only opened when a load requirement of the consumer is present. The supply valve can be continuously opened in order to adapt a volume flow of vaporized cryogen to the load requirement of the consumer.

According to a further embodiment, during step d), the supply valve is controlled with the aid of an open-loop and closed-loop control device based on sensor signals from a pressure sensor arranged downstream from the supply valve, and/or from a flow sensor.

“Downstream” here means viewed along a flow direction of the cryogen from the storage vessel to the consumer. The open-loop and closed-loop control device is configured to receive sensor signals from the pressure sensor and/or from the flow sensor and to evaluate them suitably. The open-loop and closed-loop control device can then control the supply valve on the basis of the sensor signals from the pressure sensor and/or from the flow sensor.

During step b), the supply valve is closed.

The supply valve remains closed until the load requirement of the consumer is present. As soon as the load requirement of the consumer is present, the supply valve begins to open in order to supply the consumer with the cryogen at the suitable supply pressure.

During step b), the inlet valve placed upstream from the supply valve is closed.

With the aid of the supply valve and the inlet valve, the volume can be closed off from the consumer and from the storage vessel. The volume is thus placed, arranged or provided between the inlet valve and the supply valve. In the present case, “upstream” is to be understood with reference to the flow direction of the cryogen from the storage vessel to the consumer.

According to a further embodiment, the inlet valve is closed as long as the pressure in the volume is greater than the pressure prevailing in the storage vessel.

As long as the inlet valve is closed, no cryogen can thus flow out of the storage vessel into the volume. Due to the fact that the inlet valve is closed, the cryogen is prevented from being pushed from the volume back into the storage vessel, as long as the pressure in the volume is greater than the pressure prevailing in the storage vessel.

The inlet valve is opened as soon as the pressure in the volume drops below the pressure prevailing in the storage vessel.

As soon as the inlet valve is open, the cryogen can flow out of the storage vessel into the volume. With the aid of the supply valve, the pressure prevailing in the storage vessel can then be reduced to the suitable supply pressure for the consumer. The cryogen from the storage vessel can be vaporized with the aid of a vaporizer unit associated with the volume.

According to a further embodiment, heat is introduced into the cryogen during step c) with the aid of a vaporizer unit in order to vaporize the cryogen.

The vaporizer unit can, for example, be or comprise an electrical heating device. The vaporizer unit can, for example, also be any heat exchanger or recuperator. The vaporizer unit can be part of the volume.

Furthermore, a conveying device for supplying a consumer with a cryogen from a storage vessel is proposed. The conveyor device comprises an inlet valve which is arranged between the storage vessel and the volume, a supply valve which is arranged between the volume and the consumer, a volume which can be closed off from the consumer and from the storage vessel, a vaporizer unit, and an open-loop and closed-loop control device, wherein the open-loop and closed-loop control device is configured to control the inlet valve in such a way that the inlet valve introduces a part of the cryogen from the storage vessel into the volume, wherein the open-loop and closed-loop control device is configured to control the inlet valve and the supply valve in such a way that the inlet valve and the supply valve close off the volume from the consumer and from the storage vessel, wherein the open-loop and closed-loop control device is configured to first close the supply valve and then to close the inlet valve, wherein the vaporizer unit is configured to vaporize the cryogen accommodated in the closed-off volume so as to subject the closed-off volume to a pressure which is higher than a pressure prevailing in the storage vessel, wherein the open-loop and closed-loop control device is configured to control the supply valve in such a way that the supply valve discharges the vaporized cryogen from the closed-off volume to the consumer when the consumer has a load requirement, and wherein the open-loop and closed-loop control device is configured, when the supply valve is open, to open the inlet valve as soon as the pressure in the volume falls below the pressure prevailing in the storage vessel.

The method explained above can be carried out with the aid of the conveying device. The conveying device can comprise the storage vessel. The conveying device can also comprise the consumer. Alternatively, the storage vessel and/or the consumer can also not be part of the conveying device. The conveying device can also be part of a conveyor assembly which, in addition to the conveying device, can comprise the consumer and/or the storage vessel.

The “volume” differs from the “closed-off volume” in that, in the case of the closed-off volume, the inlet valve and the supply valve are closed in order to thus close off the volume from the consumer and from the storage vessel. The fact that the inlet valve “is configured” to introduce a part of the cryogen from the storage vessel into the volume in the present case means in particular that the inlet valve can be opened and closed so that the cryogen, in particular the liquid phase of the cryogen, can flow from the storage vessel into the volume.

The fact that the inlet valve and the supply valve “are configured” to close off the volume from the consumer and from the storage vessel means in the present case in particular that the inlet valve and the supply valve for closing off the volume can both be closed in order to thus close off the volume. The vaporizer unit is in particular suitable for vaporizing the cryogen with the aid of the introduction of heat into the cryogen. The vaporized cryogen can be supplied to the consumer from the closed-off volume with the aid of the supply valve. For this purpose, the supply valve can be opened and closed.

According to one embodiment, the supply valve is arranged downstream from the inlet valve.

This means that the supply valve is placed after the inlet valve, viewed along the flow direction of the cryogen from the storage vessel to the consumer.

According to a further embodiment, the volume is provided between the inlet valve and the supply valve.

The volume can be any hollow space which can be pressurized with the aid of the vaporization of the cryogen. As mentioned above, the volume can also be referred to as a collector, header or pressure accumulator.

According to a further embodiment, the volume is formed by means of one or more pipe loops, a pipeline, and/or a storage volume.

For example, the volume is formed by a pipe loop with a length of 15 to 20 m and a pipe diameter of 200 to 600 mm, in particular up to 400 mm. The volume can comprise a meandering, curved pipe loop. The storage volume can be any container or the like.

The conveying device further comprises the open-loop and closed-loop control device for controlling the inlet valve and/or the supply valve.

A pressure sensor and a flow sensor are preferably provided downstream from the supply valve. The pressure sensor and the flow sensor provide sensor signals to the open-loop and closed-loop control device, so that the open-loop and closed-loop control device can control the supply valve in such a way that the pressure in the volume is reduced to the supply pressure suitable for the consumer when the vaporized cryogen flows out with the aid of the supply valve.

The embodiments and features described for the method apply accordingly for the proposed conveying device, and vice versa.

In the present case, “a(n)” is not necessarily to be understood as limiting to exactly one element. It is rather the case that several elements, such as two, three, or more, may also be provided. Any other numerical word used herein is also not to be understood as meaning an exact limitation to exactly the corresponding number of elements. Rather, numerical differences upwards or downwards are possible.

Further possible implementations of the method and/or the conveying device also include combinations that are not explicitly mentioned of features or embodiments described above or below with respect to the exemplary embodiments. A person skilled in the art will also add individual aspects as improvements or additions to the respective basic form of the method and/or of the conveying device.

Further advantageous embodiments of the method and/or of the conveying device are the subject matter of the dependent claims and of the exemplary embodiments of the method and/or of the conveying device described below. Furthermore, the method and/or the conveying device are explained below in more detail with reference to the accompanying figures based upon preferred embodiments.

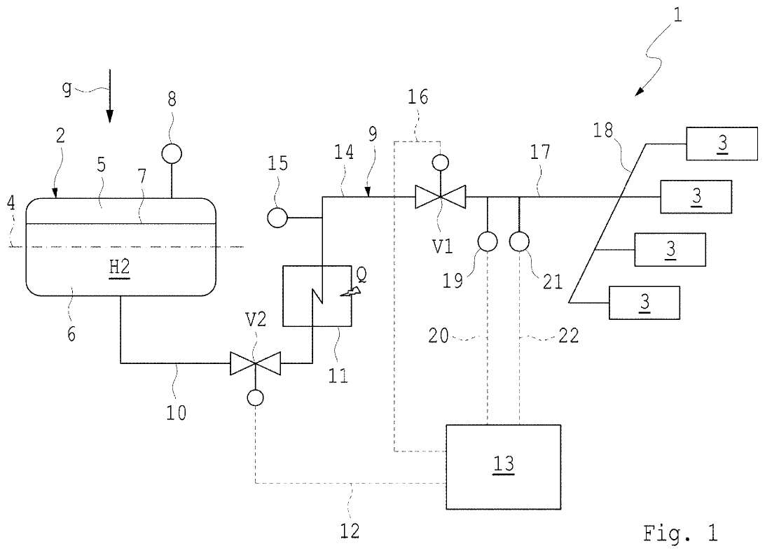

FIG. 1 shows a schematic view of an embodiment of a conveyor assembly for conveying hydrogen;

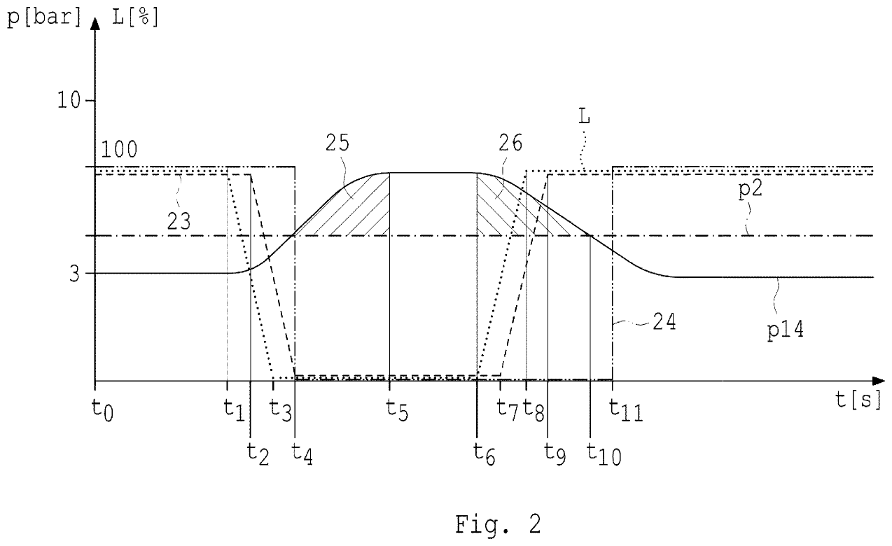

FIG. 2 shows a graph which schematically illustrates the functionality of the conveyor assembly according to FIG. 1; and

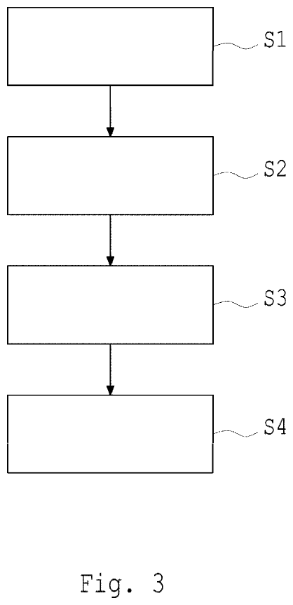

FIG. 3 shows a schematic block diagram of an embodiment of a method for supplying a consumer with a cryogen from a storage vessel.

In the figures, the same or functionally equivalent elements have been provided with the same reference signs unless otherwise indicated.

FIG. 1 shows a schematic view of an embodiment of a conveyor assembly 1 for conveying hydrogen H2 from a storage vessel 2 to a consumer 3. The conveyor assembly 1 is configured to supply the consumer 3 continuously with gaseous hydrogen H2 at a constant supply pressure of at most 6 bara, preferably from 1 to 2.5 bara, and at a temperature of approximately +10 to +25° C., independently of movements of the storage vessel 2. The conveyor assembly 1 can also be referred to as a hydrogen conveyor assembly. The storage vessel 2 and/or the consumer 3 can be part of the conveyor assembly 1.

The conveyor assembly 1 is particularly suitable for mobile applications. The conveyor assembly can preferably be part of a vehicle, in particular part of a land vehicle, of a watercraft or of an aircraft. For example, the conveyor assembly 1 is part of a ship such as a passenger ferry, a motor vehicle for example a truck or utility vehicle, or the like.

The storage vessel 2 can also be referred to as a storage tank. A plurality of storage vessels 2 can also be provided (not shown). The storage vessel 2 can be designed rotationally symmetrical with respect to a center axis or axis of symmetry 4. The axis of symmetry 4 can be oriented perpendicular to a direction of gravity g. This means that the storage vessel 2 is in a lying or horizontal position. However, the storage vessel 2 can also be positioned upright or vertically. In this case, the axis of symmetry 4 is oriented parallel to the direction of gravity g.

The storage vessel 2 is suitable for accommodating liquid hydrogen H2 (boiling point 1 bara: 20.268 K=−252.882° C.). The storage vessel 2 can therefore also be referred to as a hydrogen storage vessel or as a hydrogen storage tank. However, the storage vessel 2 can also be used for other cryogenic liquids. Examples of cryogenic fluids or liquids, or cryogens for short, are liquid helium He in addition to the aforementioned liquid hydrogen H2 (boiling point 1 bara: 4.222 K=−268.928° C.), liquid nitrogen N2 (boiling point 1 bara: 77.35 K=−195.80° C.) or liquid oxygen O2 (boiling point 1 bara: 90.18 K=−182.97° C.).

The liquid hydrogen H2 is accommodated in the storage vessel 2. As long as the hydrogen H2 is in the two-phase region, a gas zone 5 with vaporized hydrogen H2 and a liquid zone 6 with liquid hydrogen H2 can be provided in the storage vessel 2. After entering the storage vessel 2, the hydrogen H2 thus has two phases with different aggregate states, viz., liquid and gaseous. This means that, in the storage vessel 2, there is a phase boundary 7 between the liquid hydrogen H2 and the gaseous hydrogen H2. A pressure sensor 8, which can detect the pressure in the storage vessel 2, is associated with the storage vessel 2. The pressure in the storage vessel 2 is approximately 3.5 bara. The pressure in the storage vessel 2 is substantially constant.

A plurality of consumers 3 can be provided. However, only one consumer 3 is discussed below. The consumer 3 is preferably a fuel cell. In the present case, a “fuel cell” is understood to mean a galvanic cell that converts into electrical energy the chemical reaction energy of a continuously supplied fuel-in the present case, hydrogen H2—and of an oxidant—in the present case, oxygen. By means of the obtained electrical energy, an electric motor (not shown) can be driven, for example. For a stable operation of the consumer 3, it is necessary as mentioned above to supply the consumer 3 with gaseous hydrogen at a defined supply pressure.

In mobile applications, movements of the liquid hydrogen H2 accommodated in the storage vessel 2 must be expected. In the case of a horizontally-arranged, cylindrical storage vessel 2, a sloshing of the liquid hydrogen H2 over a large area is promoted by the mass inertia of the liquid hydrogen H2 and the curvature, present due to the horizontal installation, of the storage vessel 2, both against its cylindrical outer wall and against its ends.

This swashing, also known as sloshing, leads to cooling of the gas phase in the gas zone 5 above the liquid hydrogen H2 and thereby to pressure reduction of a gas cushion forming above the liquid hydrogen H2. Depending upon the movements of the storage vessel 2, this can have undesirable effects on the supply pressure available for operating components of the consumer 3, which can lead to an unstable operation of the consumer 3.

In order to provide the suitable supply pressure for the consumer 3, it is possible to use a liquid-cooled and liquid-stored pump for pumping liquid hydrogen. However, such a pump has moving parts. In addition, in the case of intermittent operation of the pump, bubbles can form in the liquid hydrogen H2 due to heating of said pump. This may lead to a malfunctioning of the pump. Alternatively, the hydrogen H2 can first be vaporized and then brought to the necessary supply pressure using a compressor. However, this is unfavorable in terms of energy use.

Furthermore, the storage vessel 2 can also be operated directly at the supply pressure. In this case, an equilibrium with the liquid phase and the gas phase layered thereabove is established in storage vessel 2. Due to the low surface tension of liquid hydrogen, a movement of the storage vessel 2, for example, when the latter is arranged in or on a vehicle as mentioned above, leads to the liquid phase and the gas phase being mixed with one another, and the liquid hydrogen H2 thereby cooling the warmer gaseous hydrogen H2. It is then not possible to maintain the supply pressure until an equilibrium is established between the temperature of the liquid hydrogen H2 and the gaseous hydrogen H2. These aforementioned problems must be solved with the aid of the conveyor assembly 1.

The conveyor assembly 1 has a conveying device 9. In contrast to the conveyor assembly 1, the storage vessel 2 and/or the consumer 3 are preferably not part of the conveying device 9. However, it is not ruled out that the storage vessel 2 and/or the consumer 3 are part of the conveying device 9.

The conveying device 9 comprises a line 10 which leads out from the storage vessel 2 below the phase boundary 7, i.e., in the region of the liquid zone 6. With the aid of the line 10, the liquid hydrogen H2 can be supplied from the storage vessel 2 to an inlet valve V2 of the conveying device 9. A vaporizer unit 11 is placed downstream from the inlet valve V2. The vaporizer unit 11 is suitable for vaporizing the liquid hydrogen H2 by introducing heat Q.

The inlet valve V2 is operatively connected via an operative connection 12 to an open-loop and closed-loop control device 13 of the conveying device 9. The operative connection 12 can be a data connection. The operative connection 12 can be wireless or wired. The open-loop and closed-loop control device 13 is suitable for opening and closing the inlet valve V2 as needed. The open-loop and closed-loop control device 13 can also be suitable for receiving and/or evaluating sensor signals from the pressure sensor 8.

A header 14 leads from the inlet valve V2 to a supply valve V1. The vaporizer unit 11 can be part of the header 14. The header 14 can be guided through the vaporizer unit 11. The vaporizer unit 11 can be connected to the header 14. A “header” is to be understood in particular as an enclosed volume which can be pressurized. In particular, a “header” is to be understood in the present case to mean a volume which is located between the valves V1, V2 and can be pressurized.

The header can also be referred to as a volume, pressure accumulator or collector. The terms “header”, “volume”, “pressure accumulator” or “collector” can accordingly be exchanged with one another as desired. The header 14 can be realized, for example, by a tube loop or a plurality of tube loops with, for example, a length of 15 to 20 m and a diameter of 200 to 250 mm. The pipe loop can run in a meandering manner. A pressure of 3 to 10 bara can prevail in the header 14.

The header 14 is also part of the conveyor device 9. A pressure sensor 15 for monitoring the pressure of the header 14 is connected to the header 14. The pressure sensor 15 is placed in the header 14 downstream from the vaporizer unit 11 and upstream from the supply valve V1. The terms “downstream” and “upstream” are to be understood with regard to a flow direction of the hydrogen H2 from the storage vessel 2 to the consumer 3. The pressure sensor 15 can communicate with the open-loop and closed-loop control device 13 in such a way that the open-loop and closed-loop control device 13 receives and/or evaluates sensor signals of the pressure sensor 15.

The supply valve V1 is coupled to the open-loop and closed-loop control device 13 via an operative connection 16. The operative connection 16 can be a data connection. The operative connection 16 can be wireless or wired. The open-loop and closed-loop control device 13 is suitable for opening and closing the supply valve V1 as needed.

A line 17 and a distributor 18 which distributes the gaseous hydrogen H2 to a plurality of consumers 3 are connected downstream from the supply valve V1. In the event that only one consumer 3 is provided, the distributor 18 can be omitted. A pressure of 1 to 2.5 bara, i.e., a suitable supply pressure for the consumer 3, prevails in the line 17 and/or in the distributor 18. The pressure in the header 14 is thus significantly higher compared to the pressure in the line 17 and/or the distributor 18.

The line 17 has a pressure sensor 19 which is coupled to the open-loop and closed-loop control device 13 via an operative connection 20. Furthermore, the line 17 comprises a flow sensor 21 which is coupled to the open-loop and closed-loop control device 13 via an operative connection 22. The open-loop and closed-loop control device 13 is configured to evaluate sensor signals from the pressure sensor 19 and/or from the flow sensor 21, and to receive them via the operative connections 20, 22.

The functionality of the conveyor assembly 1 or of the conveying device

9 is explained below with reference to FIG. 2, which shows a graph in which a pressure p in the storage vessel 2 or in the header 14 and a load or load requirement L of the consumer 3 are plotted over the time t.

In FIG. 2, the time t in seconds is plotted on the right axis. The pressure p in the storage vessel 2 or in the header 14 is plotted in bar on the vertical axis, and the load requirement L of the consumer 3 is plotted in percent. A pressure p14 prevailing in the header 14 is shown by a solid line. A pressure p2 prevailing in the storage vessel 2, which is substantially constant, is illustrated with a dot-and-dash line. A dashed line 23 represents an opening and closing behavior of the supply valve V1. A double dot-dashed line 24 represents an opening and closing behavior of the inlet valve V2. The load requirement L of the consumer 3 is shown with a dotted line.

At a time to, both valves V1, V2 are completely open. As long as the consumer 3 has a load requirement L, the inlet valve V2 is open and the supply valve V1 controls the flow of gaseous hydrogen H2 to the consumer 3. This takes place on the basis of sensor data from the pressure sensor 19 and/or from the flow sensor 21 with the aid of the open-loop and closed-loop control device 13. The vaporizer unit 11 vaporizes the liquid hydrogen H2 from the storage vessel 2.

At a time t1, the load requirement L begins to be reduced. According to the decreasing load requirement L, the supply valve V1 is closed with a slight delay starting at a time t2. At a time t3, the load requirement L is zero percent. The supply valve V1 is completely closed with a slight delay at a time t4. At the time t3, the inlet valve V2 is still completely open. At the time t4, the inlet valve V2 is completely closed. Starting from the time t4, the consumer 3 is accordingly also no longer supplied with hydrogen H2. The consumer 3 is supplied with hydrogen H2 only in the event of a load requirement L.

The header 14 now forms a closed volume starting at the time t4. With the aid of the vaporizer unit 11, the header 14 can now be pressurized by vaporizing the liquid hydrogen H2 from the storage vessel 2. For this purpose, the vaporizer unit 11 introduces heat Q into the liquid hydrogen H2. The vaporization of the hydrogen H2 is indicated in the graph with the aid of a hatched region 25. At a time t5, the hydrogen H2 in the header 14 and in the vaporizer unit 11 is completely vaporized and, as mentioned above, a pressure of 3 to 10 bara prevails in the header 14.

The hatched region 25 represents in particular the pressure build-up by post-vaporization of the liquid hydrogen H2 still present in the vaporizer unit 11. In normal operation, the vaporizer unit 11 is not filled completely with gas, but in pipes of the vaporizer unit 11, a liquid is produced from the load and the heat transfer. This liquid level of the liquid hydrogen H2 is used for pressure build-up. At the time t5, all hydrogen H2 is vaporized in the vaporizer unit 11 and in the header 14.

At an arbitrary time t6 at which both valves V1, V2 are still closed, there is a load requirement L of the consumer 3. The supply valve V1 is opened with a slight delay at a time t7 and is controlled on the basis of sensor data from the pressure sensor 19 and from the flow sensor 21 via the open-loop and closed-loop control device 13 in such a way that the consumer 3 is supplied with gaseous hydrogen H2 with a suitable supply pressure as mentioned above. A rapid approach of the consumer 3 is possible by the hydrogen H2 stored in the header 14, as indicated in FIG. 2 with the aid of a hatched region 26.

Since a high pressure p14 now prevails in the header 14 at the time t6, it is possible to immediately supply the consumer 3 with gaseous hydrogen H2. It is then possible to dispense with first filling the vaporizer unit 11 and vaporizing the liquid hydrogen H2 under the load requirement L. At a time t8, the load requirement is 100 percent. The supply valve V1 is completely opened with a short delay at a time t9. The inlet valve V2 is still closed at the time t9.

At a time t10, the pressure in the header 14 falls below the pressure in the storage vessel 2. With a short delay, the inlet valve V2 can be opened again at a time t11 in order to charge the vaporizer unit 11 and/or the header 14 with liquid hydrogen H2 from the storage vessel 2. The consumer 3 can be supplied again with the suitable supply pressure via the supply valve V1.

FIG. 3 shows a schematic block diagram of an embodiment of a method for supplying the consumer 3 with hydrogen H2 from the storage vessel 2. The method is carried out with the aid of the conveyor assembly 1 or the conveying device 9.

In the method, in a step S1, a part of the hydrogen H2 from the storage vessel 2 is introduced into the header 14 that can be closed off from the consumer 3 and from the storage vessel 2. For this purpose, the inlet valve V2 is open. In a step S2, the header 14 is closed off from the consumer 3 and from the storage vessel 2. For this purpose, the supply valve V1 is closed during step S2. During step S2, the inlet valve V2 placed upstream from the supply valve V1 is also closed.

In a step S3, the hydrogen H2 is vaporized in the closed-off header 14 so as to subject the header 14 to the pressure p14 which is higher than the pressure p2 prevailing in the storage vessel 2. During the step S3, heat Q is introduced into the liquid hydrogen H2 in the header 14 with the aid of the vaporizer unit 11 in order to completely vaporize the liquid hydrogen H2 in the header 14.

In a step S4, in the event of a load requirement L of the consumer 3, the vaporized hydrogen H2 is discharged from the header 14 to the consumer 3. During step S4, the pressure p14 prevailing in the header 14 is reduced to the supply pressure suitable for the consumer 3 when the hydrogen H2 is discharged from the header 14 with the aid of the supply valve V1. The supply pressure suitable for the consumer 3 is smaller than the pressure p2 prevailing in the storage vessel 2.

During step S4, the supply valve V1 is opened in dependence on the load requirement L of the consumer 3. The supply valve V1 is controlled with the aid of the open-loop and closed-loop control device 13 on the basis of sensor signals from the pressure sensor 19 arranged downstream from the supply valve V1 and/or sensor signals of the flow sensor 21.

The inlet valve V2 remains closed as long as the pressure p14 in the header 14 is greater than the pressure p2 prevailing in the storage vessel. The inlet valve V2 is opened as soon as the pressure p14 in the header 14 drops below the pressure p2 prevailing in the storage vessel.

Although the present invention has been described with reference to exemplary embodiments, it can be modified in many ways within the scope of the claims.

### REFERENCE SIGNS USED

1 Conveyor assembly
2 Storage vessel
3 Consumer
4 Axis of symmetry
5 Gas zone
6 Liquid zone
7 Phase boundary
8 Pressure sensor
9 Conveying device
10 Line
11 Vaporizer unit
12 Operative connection
13 Open-loop and closed-loop control device
14 Header/volume
15 Pressure sensor
16 Operative connection
17 Line
18 Distributor
19 Pressure sensor
20 Operative connection
21 Flow sensor
22 Operative connection
23 Line
24 Line
25 Region
26 Region
g Direction of gravity
H2 Hydrogen/cryogen
L Load requirement
p Pressure
p2 Pressure
p14 Pressure
Q Heat
S1 Step
S2 Step
S3 Step
S4 Step
t Time
t0 Time
t1 Time
t2 Time
t3 Time
t4 Time
t5 Time
t6 Time
t7 Time
t8 Time
t9 Time
t10 Time
t11 Time
V1 Supply valve
V2 Inlet valve

1. A method for supplying a consumer with a cryogen from a storage vessel, with the following steps:
a) introducing part of the cryogen from the storage vessel into a volume that can be closed off from the consumer and from the storage vessel;
b) closing off the volume from the consumer and from the storage vessel by first closing a supply valve arranged between the volume and the consumer, and then closing an inlet valve arranged between the storage vessel and the volume;
c) vaporizing the cryogen in the volume so as to subject the volume to a pressure which is higher than a pressure prevailing in the storage vessel; and,
d) discharging the vaporized cryogen from the volume to the consumer when the consumer has a load requirement by opening the supply valve, wherein, when the supply valve is open, the inlet valve is opened as soon as the pressure in the volume falls below the pressure prevailing in the storage vessel.

2. The method according to claim 1, wherein during step d), the pressure prevailing in the volume is reduced to a supply pressure suitable for the consumer when the cryogen is discharged from the volume with the aid of the supply valve.

3. The method according to claim 2, wherein the supply pressure suitable for the consumer is less than the pressure prevailing in the storage vessel.

4. The method according to claim 2, wherein during step d), the supply valve is opened depending on the load requirement of the consumer.

5. The method according to claim 2, wherein during step d), the supply valve is controlled with the aid of an open-loop and closed-loop control device based on sensor signals from a pressure sensor arranged downstream from the supply valve and/or sensor signals from a flow sensor.

6. The method according to claim 1, wherein the inlet valve is closed as long as the pressure in the volume is greater than the pressure prevailing in the storage vessel.

7. The method according to claim 1, wherein heat is introduced into the cryogen during step c) with the aid of a vaporizer unit in order to vaporize it.

8. A conveyor device for supplying a consumer with a cryogen from a storage vessel, comprising:
an inlet valve which is arranged between the storage vessel and the volume;
supply valve which is arranged between the volume and the consumer;
a volume which can be closed off from the consumer and from the storage vessel;
a vaporizer unit; and,
an open-loop and closed-loop control device;
wherein the open-loop and closed-loop control device is configured to control the inlet valve in such a way that the inlet valve introduces a part of the cryogen from the storage vessel into the volume;
wherein the open-loop and closed-loop control device is configured to control the inlet valve and the supply valve in such a way that the inlet valve and the supply valve close off the volume from the consumer and from the storage vessel;
wherein the open-loop and closed-loop control device is configured to first close the supply valve and then to close the inlet valve;
wherein the vaporizer unit is configured to vaporize the cryogen accommodated in the closed-off volume so as to subject the closed-off volume to a pressure which is higher than a pressure prevailing in the storage vessel;
wherein the open-loop and closed-loop control device is configured to control the supply valve in such a way that the supply valve discharges the vaporized cryogen from the closed-off volume to the consumer when the consumer has a load requirement; and,
wherein the open-loop and closed-loop control device is configured, when the supply valve is open, to open the inlet valve as soon as the pressure in the volume falls below the pressure prevailing in the storage vessel.

9. The conveying device according to claim 8, wherein the supply valve is arranged downstream from the inlet valve.

10. The conveying device according to claim 8, wherein the volume is provided between the inlet valve and the supply valve.

11. The conveying device according to claim 8, wherein the volume is formed by means of one or more pipe loops, a pipeline, and/or a storage volume.
